(19) United States
(12) Patent Application Publication
(10) Pub. No.: US 2008/0100998 A1
(43) Pub. Date: May 1, 2008

(54) Waterproof Screen Cover

(75) Inventors: John Lee Bernard Sansom, Isle of Man (GB); Philip W. Phillips, Isle of Man (GB); Geoffrey Auban Walker, Isle of Man (GB)

Correspondence Address: KENNEDY COVINGTON LOBDELL & HICKMAN, LLP, 214 N. TRYON STREET, HEARST TOWER, 47TH FLOOR, CHARLOTTE, NC, 28202, US

(73) Assignee: Wetcover Limited, Isle of Man (GB)

(21) Appl. No.: 11/667,228

(22) PCT Filed: Nov. 9, 2005
(86) PCT No.: PCT/GB05/04309

§ 371 Date: May 8, 2007

(30) Foreign Application Priority Data
Nov. 10, 2004 (GB) 0424773.0

(51) Int. Cl. G06F 1/16

(52) U.S. Cl. 361/681

(57) ABSTRACT

A touch screen cover or overlay for use in association with a user input device having a touch screen disposed within a housing, comprises a membrane (2) of a size sufficient to cover the touch screen. The membrane (2) is formed of a flexible material, and includes means (3) for removably maintaining it in a predetermined position over the touch screen. The surface of the membrane which in use faces the touch screen includes a plurality of spacer bumps (1).

The present invention relates to a cover or overlay for display screens and more specifically for touch screens.

Touch screens as user input devices are widely used in the cash register and Point of Sale (POS) industry in place of the mechanical keyboards which have either conventional raised buttons or are of a flat keyboard type. The touch screen generally comprises a rigid surface on which is displayed a plurality of “keys” or “buttons” which when touched by the user will cause the device to execute an associated command or function. The touch screen typically comprises a display of one more visual cues to the user and may provide multiple “keyboard” designs to facilitate operation in different modes. The touch screen serves to register user input provided in association with the cues and as such allows data to be entered. The touch screen is usually housed and supported within a plastic bezel.

It is known to provide a flexible transparent screen cover or overlay for use with a touch screen to prevent damage and degradation thereto. The screen cover provides a relatively inexpensive and replaceable shield that can protect the touch screen surface from the action of fingers and other articles pressing against it, whilst not impeding the actual use of the touch screen as a data input device.

A known touch screen cover essentially comprises a flexible membrane which is disposed within a housing, and means for maintaining the membrane in a predetermined position over the contact surface of the touch screen. The size of the touch screen cover is at least sufficient to cover those parts of the touch screen which display data inputting characters or cues. The surface of the touch screen cover in contact with the touch screen is essentially flat or uniform, and consequently there is a tendency for air to become trapped between it and the screen. These bubbles of air between the touch screen cover and the touch screen cause the screen cover to become unstable and subject to non-uniform tension. This can result in difficulties in entering data onto the touch screen through the touch screen cover.

It is an object of the present invention to provide a touch screen cover or overlay which obviates or at least substantially mitigates the problems referred to hereinbefore of the prior art.

According to the present invention there is provided a touch screen cover or overlay for use in association with a user input device having a touch screen disposed within a housing, said touch screen cover or overlay comprising a membrane of a size sufficient to cover the touch screen, said membrane being formed of a flexible material, and means for removably maintaining said membrane in a predetermined position over the touch screen, wherein the surface of the membrane which in use faces the touch screen includes a plurality of spacer bumps.

The spacer bumps are distributed over the surface of the membrane to maintain a uniform spacing between the membrane and the touch screen. The spacer bumps improve the relationship between the membrane and the touch screen causing the membrane to lay in a more stable manner, and ensuring that air does not become trapped between the membrane and the touch screen.

The spacer bumps may be formed integrally to the membrane.

The membrane may be made from a plastic or silicon rubber material.

The spacer bumps may be rectangular, square, circular or be of a regular or irregular polygon shape.

Preferably, the spacer bumps are between 0.1 mm and 1.0 mm in height.

Preferably, the spacer bumps have a pitch of between 1 mm and 10 mm and this pitch may be constant or variable within the limits of the minimum and maximum pitch. The pitch of the raised bumps applies to both the horizontal direction and the vertical direction.

Preferably, the diameter or width of each spacer bump is between 0.2 and 2.0 mm.

The spacer bumps may be provided over the entire surface of the membrane or over a portion thereof. The spacer bumps may also be of different heights and/or of different pitches on different parts of the membrane.

The size (surface area) of the touch screen cover may be substantially the same as that of the touch screen without extending over the touch screen housing. Alternatively, the size (surface area) of the touch screen cover may extend beyond the touch screen so that the touch screen cover extends over the face of the touch screen housing on all four sides thereof. The touch screen cover may extend to the outside edge of the face of the touch screen housing.

The touch screen cover may be held in place on the touch screen housing by an adhesive. Alternatively, a mechanical fixing may be provided to retain the touch screen cover in place.

An embodiment of the present invention will now be described, by way of example, with reference to the accompanying drawings, in which:

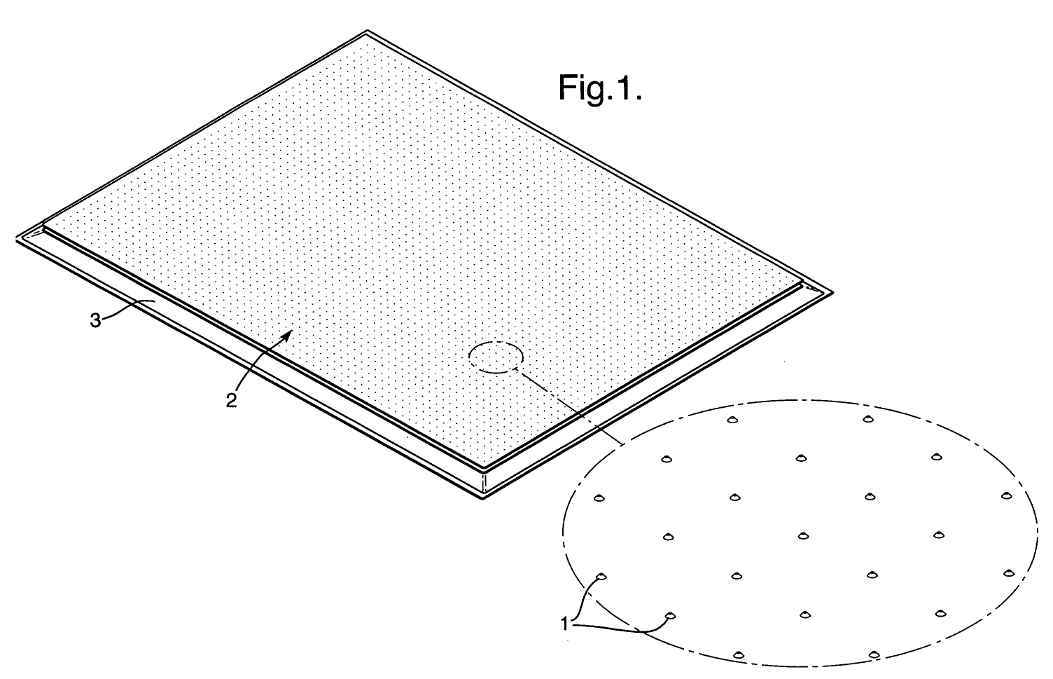

FIG. 1 is a perspective view of a screen cover according to the present invention including an enlargement of a section of the cover; and

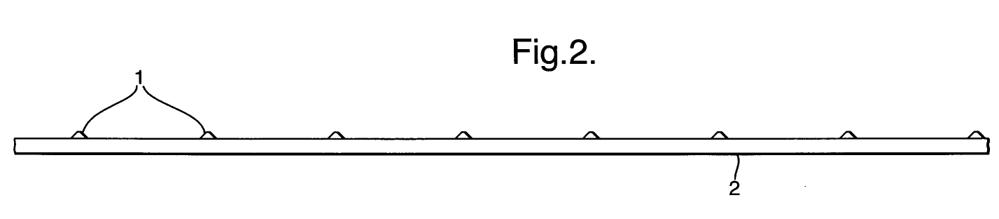

FIG. 2 is a cross-sectional view through a section of a screen cover according to the present invention.

Referring to the drawings there is shown a touch screen cover for a touch screen in accordance with the present invention. The touch screen cover comprises a flexible membrane 2 of plastic or silicon rubber material supported around its periphery by mounting means 3. The mounting means 3 is moulded to fit within the housing of a touch screen, with the inner surface of the touch screen cover lying against the touch screen itself. As shown the mounting means 3 is formed integrally to the membrane 2, but it will be appreciated that the mounting means 3 may take the form of a separate frame to which the membrane is attached about its entire periphery.

The inner surface of the membrane 2 that is to say the surface which in use lies against the touch screen, has a series of raised bumps 1 in it. These bumps 1 cause the membrane 2 to stand off from or be spaced from the surface of the touch screen. This allows the membrane to lie over the touch screen in a stable manner, thus preventing the formation of areas of tension within the membrane and of air bubbles between it and the touch screen. The spacer bumps 1 as shown in the drawings are circular, but other shapes can be used within the scope of the present invention. The spacer bumps are between 0.1 mm and 1.0 mm in height and have a pitch of between 1 mm and 10 mm. The diameter of the spacer bumps is between 0.2 mm and 2.0 mm.

1. A touch screen cover or overlay for use in association with a user input device having a touch screen disposed within a housing, said touch screen cover or overlay comprising a membrane of a size sufficient to cover the touch screen, said membrane being formed of a flexible material, and means for removably maintaining said membrane in a predetermined position over the touch screen, wherein the surface of the membrane which in use faces the touch screen includes a plurality of uniformly spaced spacer bumps.

2. A touch screen cover according to claim 1, wherein the spacer bumps are formed integrally to the membrane.

3. A touch screen cover according to claim 1 or 2, wherein the membrane is made from a plastic or silicon rubber material.

4. A touch screen cover according to claim 1, wherein the spacer bumps are rectangular, square, circular and/or of a regular or irregular polygon shape.

5. A touch screen cover according to claim 1, wherein the spacer bumps are between 0.1 mm and 1.0 mm in height.

6. A touch screen cover according to claim 1, wherein the spacer bumps have a pitch of between 1 mm and 10 mm.

7. A touch screen cover according to claim 6, wherein the pitch of the spacer bumps is variable within the limits of the minimum and maximum pitch over the surface of the membrane.

8. A touch screen cover according to claim 1, wherein the diameter or width of each spacer bump is between 0.2 and 2.0 mm.

9. A touch screen cover according to claim 1, wherein the spacer bumps are provided over a portion of the membrane.
